(19) United States
(12) Patent Application Publication
(10) Pub. No.: US 2020/0394843 A1
(43) Pub. Date: Dec. 17, 2020

(54) METHOD AND SYSTEM FOR RENDERING AUGMENTED REALITY CONTENT

(71) Applicant: Wipro Limited, Bangalore (IN)

(72) Inventor: Manjunath Ramachandra Iyer, Bangalore (IN)

(21) Appl. No.: 16/541,199

(22) Filed: Aug. 15, 2019

(30) Foreign Application Priority Data
Jun. 14, 2019 (IN) 201941023640

(51) Int. Cl. G06T 19/00; G06K 9/00; G06F 16/48; G06F 16/432

(52) U.S. Cl. CPC G06T 19/006; G06F 16/434; G06F 16/48; G06K 9/00664

(57) ABSTRACT

The present invention discloses a method and a system for rendering Augmented Reality (AR) content that adapts to changing content in a video or image. The system comprising a processor is configured to receive real-time input data from a user device, identify a plurality of objects in the real-time input data, determine association between the plurality of objects in the real-time input data and metadata of the plurality of objects, determine one or more similar associated objects from a plurality of historic objects in a database based on the determined association, select one of the one or more similar associated objects based on weightage, select at least one of an AR object and an AR action from the database for the selected similar associated objects, and render the at least one of an AR object and an AR action, with the real-time input data.

### TECHNICAL FIELD

The present subject matter is related in general to rendering Augmented Reality (AR) content, more particularly, but not exclusively to a method and a system for rendering AR content that adapts to a changing content in a video or an image.

### BACKGROUND

Augmented Reality (AR) content is gaining momentum with the availability of inexpensive rendering devices and increased consumption of digital content. AR is being used in applications such as effective administration of instructions for troubleshooting, product user guide, simulation, design of product and machineries, usability testing, etc.

One of the requirements for rendering a useful AR content is the right selection of an AR object. There exist methods that allow rendering of AR objects. These methods use a library of AR objects to support the real-time AR rendering. These AR objects are static and often selected by a user. Consequently, these AR objects do not appear or change dynamically based on the objects and actions in a content i.e. in a video or an image.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure may relate to a method for rendering AR content that adapts to a changing content in a video or an image. The method includes receiving real-time input data from a user device, identifying a plurality of objects in the real-time input data, determining association between the plurality of objects in the real-time input data and metadata of the plurality of objects, determining one or more similar associated objects from a plurality of historic objects in a database based on the determined association, selecting one of the one or more similar associated objects based on a weightage, selecting at least one of an AR object and an AR action from the database for the selected similar associated objects and rendering the at least one of an AR object and an. AR action, with the real-time input data.

The weightage may be assigned based on a similarity of metadata between each of the identified plurality of objects in the real-time input data and each of the objects in the similar associated objects.

In an embodiment, the present disclosure may relate to an assistance system tier rendering AR content that adapts to a changing content in a video or an image. The assistance system may include a processor and a memory communicatively coupled to the processor, wherein the memory stores processor-executable instructions, which on execution, may cause the processor to receive real-time input data from a user device, identify a plurality of objects in the real-time input data, determine association between the plurality of objects in the real-time input data and metadata of the plurality of objects, determine one or more similar associated objects from a plurality of historic objects in a database based on the determined association, select one of the one or more similar associated objects based on a weightage, select at least one of an AR object and an AR action from the database for the selected similar associated objects, and render the at least one of an AR object and an AR action, with the real-time input data.

In an embodiment, the present disclosure may relate to a non-transitory computer readable medium including instructions stored thereon that when processed by at least one processor cause an assistance system to perform operations comprising receiving real-time input data from a user device, identifying a plurality of objects in the real-time input data, determining association between the plurality of objects in the real-time input data and metadata of the plurality of objects, determining one or more similar associated objects from a plurality of historic objects in a database based on the determined association, selecting one of the one or more similar associated objects based on a weightage, selecting at least one of an AR object and an AR action from the database for the selected similar associated objects and rendering the at least one of an AR object and an AR action, with the real-time input data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1 illustrates an exemplary environment for rendering AR content that adapts to a changing content in a video or an image in accordance with some embodiments of the present disclosure.

FIG. 2 shows a detailed block diagram of an assistance system in accordance with some embodiments of the present disclosure.

FIG. 3a -FIG. 3b illustrate flowcharts showing a method of rendering AR content that adapts to a changing content in a video or an image in accordance with some embodiments of the present disclosure.

FIG. 4 illustrates a flowchart showing a method for populating a database to be used in rendering AR content in accordance with some embodiments of present disclosure.

FIG. 5a-FIG. 5b illustrate an exemplary representation of rendering AR content in accordance with some embodiments of present disclosure.

FIG. 6a-FIG. 6b illustrate another exemplary representation of rendering AR content in accordance with some embodiments of present disclosure.

FIG. 7 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### Detailed Description

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure relate to a method and a system for rendering AR content that adapts to a changing content in a video or an image. Typically, AR methods may produce augmented visual content along with a real-world environment. These augmented contents are static in nature i.e. augmented content do not change dynamically if the real-world environment changes. The present disclosure provides a method that may detect the objects in the real-world environment, which could be an image or a video. Thereafter, the method may identify association between the objects in the real-world environment to select one or more AR objects. Based on the selection of one or more AR objects, this method may further select an appropriate AR action and/or AR audio. Additionally, the present disclosure may allow a user to modify the one or more selected AR objects, consequently, the method may adapt the AR objects, AR actions and/or AR audio associated with the modified objects dynamically. The present disclosure rendering dynamic AR content facilitates augmentation of future actions, thereby, enhancing user-experience.

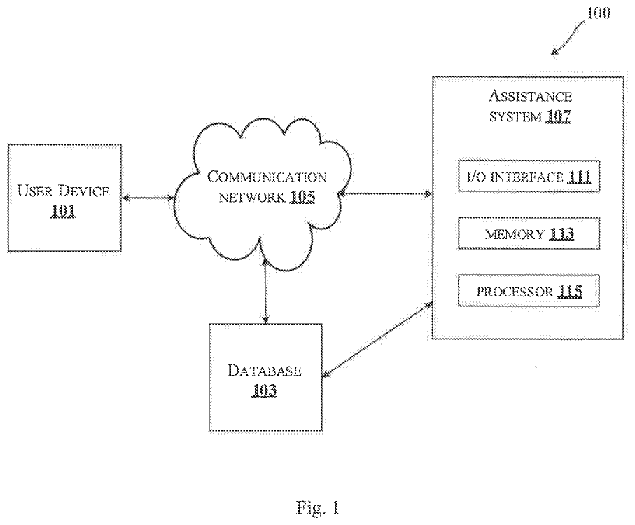

FIG. 1 illustrates an exemplary environment for rendering AR content that adapts to a changing content in a video or an image in accordance with some embodiments of the present disclosure.

As shown in the FIG. 1, the environment 100 includes a user device 1 a database 103, a communication network 105 and an assistance system 107. The user device 101 may be connected through the communication network 105 to the assistance system 107. In an embodiment, the user device 101 may include, but is not limited to, a mobile terminal, a tablet computer, AR glasses, Head Mounted Display (HMD) or any AR rendering device or an AR rendering platform. A person skilled in the art would understand that, any AR rendering devices, not mentioned explicitly, may also be used as the user device 101 in the present disclosure. The user device 101 may provide real-time input data to the assistance system 107 via the communication network 105 and may receive AR content along with the real-time input data from the assistance system 107 via the communication network 105. The real-time input data may be at least one of image and video and the AR content may be at least one of an AR object, an AR action and an AR audio. The communication network 105 may include, but is not limited to, a direct interconnection, an e-commerce network, a Peer-to-Peer (P2P) network, Local Area Network (LAN), Wide Area Network (WAN), wireless network (for example, using Wireless Application Protocol), Internet, Wi-Fi, Bluetooth and the like.

In the embodiment, the assistance system 107 may adapt the AR content according to the changing content in the real-time input data. The assistance system 107 may include an I/O interface 111, a memory 113 and a processor 115. The I/O interface 111 may be configured to receive the real-time input data from the user device 101. Analogously, the I/O interface 111 may be configured to render the AR content along with the real-time input data to the user device 101. The I/O interface 111 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video. VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

The real-time input data received by the I/O interface 111 and the AR content to he rendered through the I/O interface 111 may be stored in the memory 113. The memory 113 may be communicatively coupled to the processor 115 of the assistance system 107. The memory 113 may, also, store processor instructions which may cause the processor 115 to execute the instructions for rendering the AR content. The memory 113 may include, without limitation, memory drives, removable disc drives, etc. The memory drives may further include a drum, magnetic disc drive, magneto-optical drive, optical drive, Redundant Array of Independent Discs (RAID), solid-state memory devices, solid-state drives, etc.

The processor 115 may include at least one data processor for rendering AR content. The processor 115 may include specialized processing units such as integrated system (bus) controllers, memory management control units, floating point units, graphics processing units, digital signal processing units, etc.

In the embodiment, the assistance system 107 may exchange data with a database 103 directly or through the communication network 105. The database 103 may be populated or stored with data that includes at least one of a plurality of historic objects from historic input data, metadata related to each of the plurality of historic objects, correlation between the plurality of historic objects and AR content associated with the correlation between the plurality of historic objects. Here, the historic input data may refer to input data received from one or more data sources by the assistance system 107 during training phase. Typically, the database 103 may be used to store the input data that includes video and image. The database 103 may, also, store one or more objects identified in the input data, correlation between the one or more identified objects and metadata of each of the one or more identified objects. The input data along with the identified objects, its correlation and its metadata are stored in a table format forming a library in the database 103. The metadata may be partially filled by the system. The metadata such as location of objects, title of objects, type of objects, interaction among objects, action associated with objects, sound associated with objects and information related to events associated with objects may be populated by the assistance system 107 or by the user. The user may, also, edit the existing metadata as populated by the assistance system 107 such as title of the object and add user specific memorable metadata such as the ones associated with his/her personal events for example, “bought on Birthday”. User may, also, provide additional contextual information. An example of the table showing the organization of the library is shown in Table 1 below.

TABLE 1

| Theme | Object | Metadata | Type |
|---|---|---|---|
| Geographical | Building | Place | System generated |
| | | Visited for birthday | User defined |
| | | celebration | |
| Automotive | Screw | Action-movement | User defined or system |
| | | (right - | learnt (by observing |
| | | anticlockwise, left - | user action) |
| | | clockwise) | |
| | | metadata−>thread | |
| | | angle, orientation . . . | |

The database 103 may, also, be updated at pre-defined intervals of time. These updates may be related to addition of new objects that were not present in the database 103, correlation amongst the new objects and the plurality of historic objects present in the database 103 and the rnetadata of the new objects.

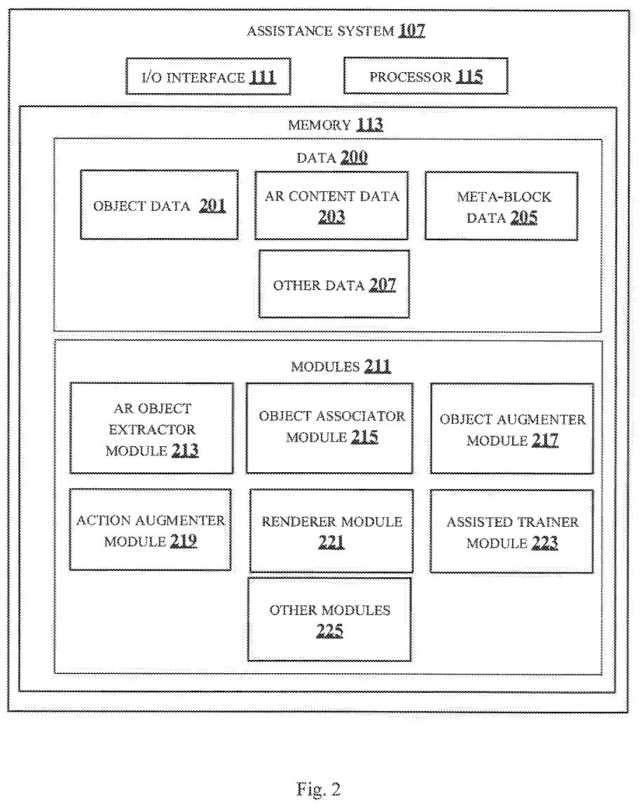

FIG. 2 shows a detailed block diagram of the assistance system 107 in accordance with some embodiments of the present disclosure.

The assistance system 107, in addition to the I/O interface 111 and processor 115 described above, may include data 200 and one or more modules 211, which are described herein in detail. In the embodiment, the data 200 may be stored within the memory 113. The data 200 may include, for example, object data 201, AR content data 203, meta-block data 205 and other data 207.

The object data 201 may include one or more objects that are identified in the real-time input data received from the user device 101. For example, if the real-time input data is an image consisting of a bird on a tree, then the objects identified in the image may be the tree and the bird and may be stored under the object data 201.

The AR content data 203 may include the one or more AR content to be rendered along with the real-time input data. The AR content may be at least one of an AR object, an AR action and an AR audio. In an embodiment, the AR content may be for example, animations, images, graphics, 3D content, audio and video. A person skilled in the art would understand that any other type of content, which may be rendered as AR, not mentioned explicitly, may also be used in the present disclosure.

The meta-block data 205 may include metadata of one or more identified objects in an image or a video and they may include at least one of location of objects, title of objects, type of objects, interaction among objects, action associated with objects, sound associated with objects and information related to events associated with objects.

The other data 207 may store data, including temporary data and temporary files, generated by modules 211 for performing the various functions of the assistance system 107.

In the embodiment, the data 200 in the memory 113 are processed by the one or more modules 211 present within the memory 113 of the assistance system 107. In the embodiment, the one or more modules 211 may be implemented as dedicated hardware units. As used herein, the term module refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality. In some implementations, the one or more modules 211 may be communicatively coupled to the processor 115 for performing one or more functions of the assistance system 107. The said modules 211 when configured with the functionality defined in the present disclosure will result in a novel hardware.

In one implementation, the one or more modules 211 may include, but are not limited to, an AR object extractor module 213, an object associator module 215, an object augmenter module 217, an action augmenter module 219, a renderer module 221 and an assisted-trainer module 223. The one or more modules 211 may, also, include other modules 225 to perform various miscellaneous functionalities of the assistance system 107.

Here, the AR object extractor module 213 and the object associator module 215 are used in a training phase. During the training phase, the database 103 is populated with data that includes at least one of a plurality of historic objects from historic input data, metadata related to each of the plurality of historic objects, correlation between the plurality of historic objects and AR content associated with the correlation between the plurality of historic objects using the AR object extractor module 213 and the object associator module 215.

The AR object extractor module 213 may receive historic input data from one or more data sources and segment the plurality of historic objects in the historic input data. The historic input data may be at least one of image and video. For instance, when a video is ingested to the AR object extractor module 213, objects in each scene of the video are extracted. In the next step, the action performed by these extracted objects may, also, be identified. The extraction of the objects in the scene may happen thorough a deep learning network. The AR object extractor module 213 may receive the at least one of image and video through the I/O interface 111. The segmented plurality of historic objects may be fed to the object associator module 215.

The object associator module 215 may identify correlation between the plurality of historic objects and metadata of the plurality of historic objects and associate the at least one of an AR object and an AR action with the identified correlation and the metadata of the plurality of historic objects. For instance, the object associator module 215 may identify the most commonly interacting objects and actions from among the objects and actions identified by the AR object extractor module 213. The correlation between the objects and actions may be learnt using a Convolutional Neural Network (CNN). This correlation between the plurality of objects may be stored in the database 103 through the communication network 105. There may be metadata of these objects stored as well in the database 103 through the communication network 105. This metadata may include interaction that is often logical and binds the objects. For example, “a bird sits on tree”. The association is most natural, common and meaningful. Eventually, the same association may be realized or recommended when a similar object is extracted in an image or a video.

Here, the object augmenter module 217, the action augmenter module 219, the renderer module 221 are used in real-time phase. During the real-time phase, real-time input data is acquired and processed by the object augmenter module 217, the action augmenter module 219 and the renderer module 221 to provide one of one or more AR objects and AR actions along with the real-time input data.

The object augmenter module 217 and the action augmenter module 219 may receive the real-time input data from the user device 101 and identify a plurality of objects in the real-time input data. In the next step, the object augmenter module 217 may determine association between the plurality of objects in the real-time input data and metadata of the plurality of objects. In the subsequent step, the object augmenter module 217 may further determine one or more similar associated objects from a plurality of historic objects in the database 103 based on the determined association and select one of the one or more similar associated objects based on a weightage. In the final step, the object augmenter module 217 and the action augmenter module 219 may select at least one of the AR object and the AR action from the database 103 for the selected similar associated objects.

The object augmenter module 217 may dynamically select one or more most appropriate AR object from the database 103 for the objects present in the real-time input data. Typically, one AR object may be chosen for one object in the real-time input data. However, more than one AR objects may be possible for one object in the real-time input data. In some cases, a user can make a selection of one of the AR objects through the user device 101. The object augmenter module 217 may receive the real-time input data from the I/O interface 111. The selected AR object may be fed to the renderer module 221.

The action augmenter module 219 may identify and select the AR action from the database 103 that may be associated with the AR objects selected by the object augmenter module 217 as well as the identified objects present in the real-time input data. For example, for a bird in an image, the mostly likely AR object can be a tree, the AR action can be the bird flying away from the tree and the AR audio can be a chirping sound of the bird. Another example may involve a buyer of a car focusing camera (with a headphone) over a certain model of the car parked in a showroom. The buyer can see how the car moves (AR action) making a roaring sound (AR audio) at different speeds and jerks. The AR action may involve animation and may be applied over the objects themselves. The action augmenter module 219 may receive the real-time input data from the I/O interface 111 and the selected AR object from the object augmenter module 217. The selected AR action may be fed to the renderer module 221.

The renderer module 221 may render at least one of the AR object and the AR action, with the real-time input data. The renderer module 221 may perform the formatting and displaying of the AR object and/or AR action. The selected AR object may be positioned in proximity to the identified object in the real-time input data. The renderer module 221 may receive the selected AR object from the object augmenter module 217 and the selected AR action from the action augmenter module 219. The at least one of the AR object and the AR action along with the real-time input data may, also, be provided to the assisted trainer module 223 for the user to edit or refine the library in the database 103.

The assisted trainer module 223 may receive the at least one of the AR object and the AR action along with the real-time input data from the renderer module 221. This received input by the assisted trainer module 223 may be sent to the user device 101 for the user to edit. The user may edit or make minor changes to position of the AR object or AR action or change the AR object or AR action itself by selecting a new AR object or AR action from the database 103. This preference of the user may be stored in the database 103 for subsequent usages as a part of adaptive learning and this updated preference is provided next time. For example, if the user picks pine tree instead of mango tree for the suggested background for a parrot, from next time pine tree may be associated with the parrot instead of the mango tree. In an embodiment, the assisted trainer module 223 may receive at least one of the AR object and the AR action directly from the object augmenter module 217 and the action augmenter module 219, respectively. This received input may be sent to the user device 101 for the user to edit. The user may edit or make minor changes to position of the AR object or AR action or change the AR object or AR action itself by selecting a new AR object or AR action from the database 103. This preference of the user may be stored in the database 103 for subsequent usages as a part of adaptive learning and this updated preference is provided next time. Subsequently, the new AR object or AR action along with the real-time input data may be sent to the renderer module 221 for rendering.

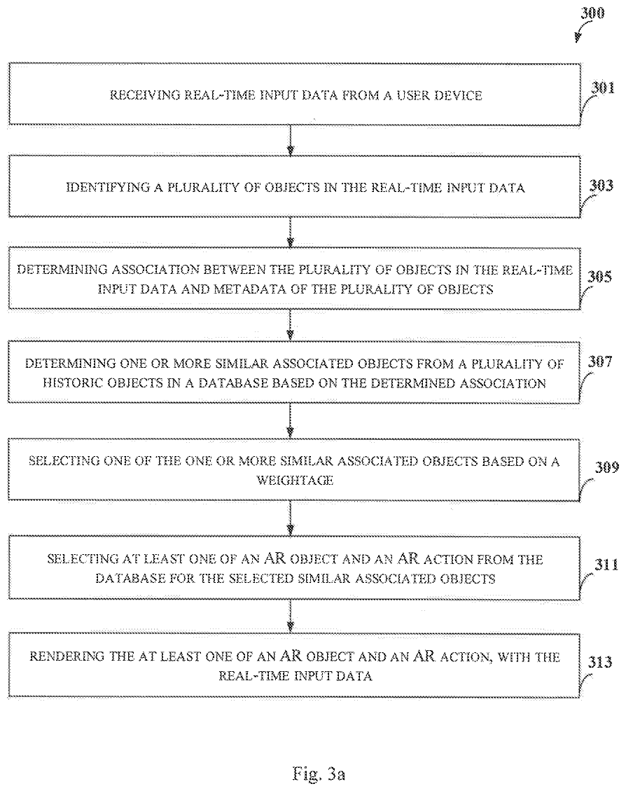

FIG. 3a illustrates a flowchart showing a method of rendering AR content that adapts to changing content in a video or an image in accordance with some embodiments of the present disclosure and FIG. 3b illustrates a flowchart showing a method of rendering step of AR content in detail with or without user input.

As illustrated in FIG. 3a-FIG. 3b, the method 300 includes one or more blocks for rendering AR content that adapts to changing content in a video or an image. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the real-time input data from a user device 101 is received by the object augmenter module 217 and the action augmenter module 219. Here, the real-time input data may be at least one of image and video.

At block 303, the object augmenter module 217 may identify one or more objects present in the real-time input data. At this stage, the real-time input data is, also, received by the action augmenter module 219.

At block 305, the object augmenter module 217 may determine the association between the objects identified in block 303. Furthermore, the metadata associated with the identified objects may, also, be determined by the object augmenter module 217.

At block 307, based on the association determined between the objects in block 305, the object augmenter module 217 determines one or more similar associated objects from a plurality of historic objects stored in the database 103.

At block 309, the object augmenter module 217 may select one of the one or more similar associated objects determined in block 307. This selection is based on a weightage, which is assigned based on a similarity of rnetadata between each of the identified plurality of objects in the real-time input data and each of the objects in the similar associated objects determined in the database 103.

At block 311, the object augmenter module 217 may select an AR object from the database 103 for the selected similar associated objects. At this stage, the selected AR object may be sent to the action augmenter module 219. Based on the selected AR object and the real-time input data, the action augmenter module 219 may select a relevant AR action and AR audio from the database 103, if applicable.

At block 313, the renderer module 221 may receive the selected at least one of the AR object, the AR action and the AR audio from the object augmenter module 217 and the action augmenter module 219. The renderer module 221 may render at least one of the AR object, the AR action and the AR audio with the real-time input data to the user device 101.

FIG. 3b illustrates a flowchart showing a method for rendering step of AR content in detail with or without user input.

At block 313, the renderer module 221 may receive at least one of the AR object and the AR action selected by the object augmenter module 217 and the action augmenter module 219. The renderer module 221 may render the AR object and/or the AR action with the real-time input data. At this stage, while rendering, the renderer module 221 may present an option on the user device 101 for the user to make changes to the AR object and/or the AR action.

At block 315, when the user decides not to intervene or make changes to the AR object and/or the AR action, the renderer module 221 may superimpose the AR object and/or the AR action over the real-time input data.

At block 317, the renderer module 221 may provide the superimposed real-time input data to the user device 101.

At block 319, when the user decide's to intervene or make changes to the one or more objects present in the real-time input data, the renderer module 221 may receive at least one modified object from the user device 101. For example, a dog (an object in a real-time input data) licking a bone in front of a building may be replaced by a cow (a modified object) from the user device 101.

At block 321, the renderer module 221 may determine one or more similar objects from the plurality of historic objects present in the database 103 based on the association with the one or more modified objects received from the user device 101. For example, when a dog (an object in a real-time input data) licking a bone in front of a building is replaced by a cow (a modified object), the bone licked by the dog is automatically replaced by grass. The association or interaction between the dog and the bone is determined when choosing the grass (a similar object) for the cow (the modified object).

At block 323, the renderer module 221 may select one or more modified AR objects and modified AR actions from the database 103 for the one or more similar objects determined in block 321.

At block 325, the renderer module 221 may superimpose the one or more modified AR objects and modified AR actions along with the one or more modified objects over the real-time input data.

At block 327, the renderer module 2.21 may provide the superimposed real-time input data to the user device 101.

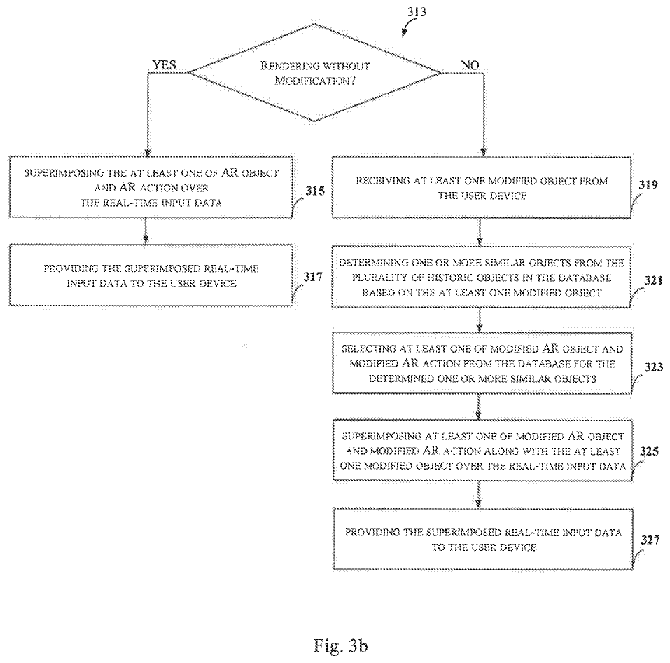

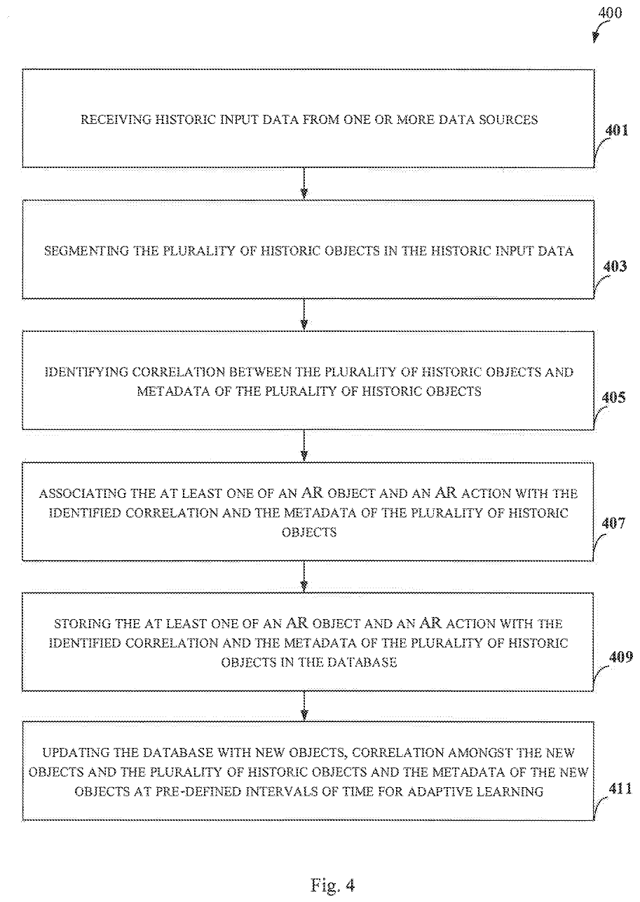

FIG. 4 illustrates a flowchart showing a method for populating the database 103 to be used in rendering AR content in accordance with some embodiments of present disclosure.

At block 401, the AR object extractor module 213 may receive historic input data from one or more data sources. The historic input data may be at least one of image and video.

At block 403, the AR object extractor module 213 may segment one or more historic objects present in the historic input data. The segmented one or more historic objects is sent to the object associator module 215.

At block 405, the object associator module 215 may identify correlation between the one or more historic objects and their metadata.

At block 407, the object associator module 215 may associate one or more AR objects and AR actions with the identified correlation between the one or more historic objects and their metadata.

At block 409, the object associator module 215 may store the one or more AR objects and AR actions along with the correlation between the one or more historic objects and their metadata in the database 103.

In some embodiment, the historic input data may include audio in addition to the at least one of image and video. In such situation, the steps involving the block 401 to the block 409 may be performed to store one or more AR audios along with the one or more A.R. objects and AR actions and the correlation between the one or more historic objects and their metadata in the database 103.

At block 411, when a new input data is received from the user device 101, the steps involving the block 401 to the block 409 may be performed to identify new objects in the new input data, identify correlation amongst the new objects and the plurality of historic objects and identify the metadata of the new objects. This information may be updated in the database 103 at pre-defined intervals of time.

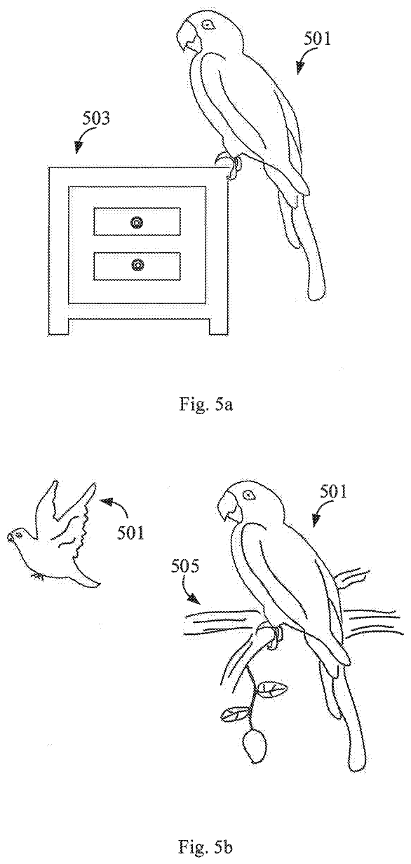

FIG. 5a-FIG. 5b illustrate an exemplary representation of rendering AR content in accordance with some embodiments of present disclosure.

In this example, rendering of AR content i.e. AR object and AR action is explained. Consider a situation where a parrot 501 is sitting on a table 503, as shown in FIG. 5a. For a parrot, natural environment is a tree, where it generally sits. When a user focuses the user device 101 on the parrot 501 sitting on the table 503, this input image may be received by the object augmenter module 217 and the action augmenter module 219. The objects in the image i.e. the parrot 501 and the table 503 are identified by the object augmenter module 217 and their association i.e. the parrot 501 is sitting on the table 503 is determined. Based on this identified association, similar such associations are determined in the database 103. For example, a parrot on a mango tree, a crow on a mango tree or a sparrow on an apple tree could be such similar associations determined in the database 103. Since there could be more than one similar association possible from the database 103, the selection of single association from a plurality of such associations is done based on a weightage. Here, the weightage is assigned based on a similarity of metadata between each of the identified plurality of objects in the input image and each of the objects in the similar associated objects in the database 103. In this example, the parrot on the mango tree may have highest weightage in comparison to the crow on the mango tree or the sparrow on the apple tree based on similarity of metadata i.e. parrot. Based on the highest weightage, the mango tree 505 may be selected as an AR object by the object augmenter module 217. This AR object may be sent to the action augmenter module 219 for selecting an AR action associated with the AR object, if any. In this case, if there is an AR action related to the selected AR object, for example, parrot flying away from the tree, then the activity of parrot 501 flying away may be selected by the action augmenter module 219. The selected AR object (the tree 505) and the AR action (parrot 501 flying away from the tree 505) may be sent to the renderer module 221. The renderer module 221 may provide the selected AR object and the AR action superimposed on the input image to the user device 101. The tree 505 (selected AR object) may be superimposed on the table 503 and the parrot 501 flying away (selected AR action) is shown with respect to the tree 505, as shown in FIG. 5b. The user may through the user device 101 see the parrot 501 sitting on a mango tree 505 (augmented object) and flying away (augmented action) from the tree 505. As an option, the user can also replace the selected AR object, for example, the mango tree to the apple tree.

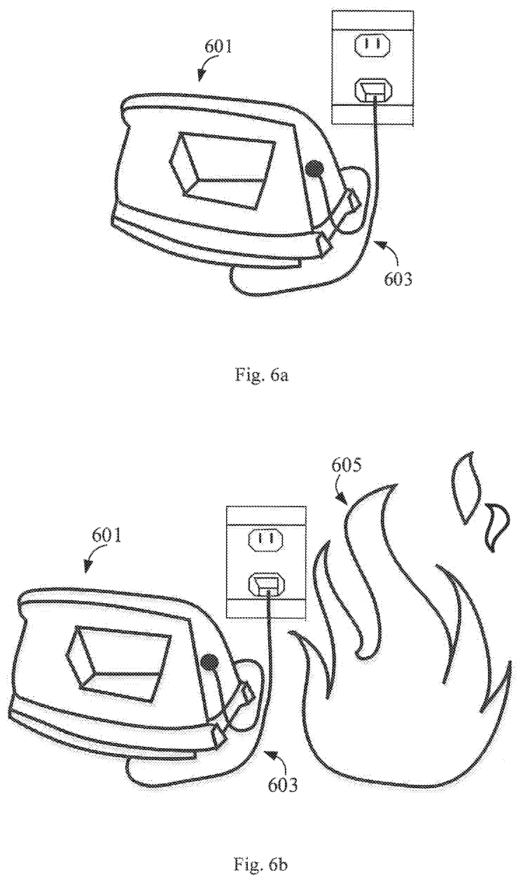

FIG. a-FIG. 6b illustrate another exemplary representation of rendering AR content in accordance with some embodiments of present disclosure.

In another example, rendering of AR content i.e. AR object and AR action is explained. Consider a situation where an iron box 601 is placed on its own wire 603, as shown in FIG. 6a. Under normal circumstances, if such a situation is not noticed, then it can lead to the wire catching fire. In the present invention, when a user focuses the user device 101 on the iron box 601 which is placed on its own wire 603, this input image may be received by the object augmenter module 217 and the action augmenter module 219. The objects in the image i.e. the iron box 601 and its wire 603 are identified by the object augmenter module 217 and their association i.e. the iron box 601 on the wire 603 is determined. Based on this identified association, similar such associations are determined in the database 103. For example, a toaster on its wire and washing machine on its wire could be similar such associations determined in the database 103. For the toaster on its wire situation may have “fire” as an AR object and for the washing machine on its wire situation may have “danger symbol” as an AR object. Since there is more than one similar association from the database 103, the selection of single association from a plurality of such associations is done based on a weightage. Here the weightage is assigned based on a similarity of metadata between each of the identified plurality of objects in the input image and each of the objects in the similar associated objects in the database 103. In this example, a toaster on its wire may have highest weightage in comparison to washing machine on its wire based on similarity of metadata. The toaster is associated with metadata ‘heat appliance’ which matches with metadata of iron box. Therefore, the toaster may have a higher weightage as compared to the washing machine. Based on the highest weightage, corresponding AR object i.e. tire 605 may be selected by the object augmenter module 217. This AR object may be sent to the action augmenter module 219 for selecting one or more AR actions associated with the AR object, if any. In this case, if there are one or more AR actions related to the selected AR object, for example, the AR action could be spread of fire from spark to large flame, then it may be selected by the action augmenter module 219. The selected AR object and the AR action may be sent to the renderer module 221. The renderer module 221 may provide the selected AR object and the AR action superimposed on the input image to the user device 101. The user may, through the user device 101, see a fire 605 (augmented object) around the iron box 601 placed on its own wire 603 further leading to large flame (augmented action, not shown in FIG.), as shown in FIG. 6b.

In the above example, AR action is augmented over the AR object, which may result in change of state of the AR object, for example, when the iron box is placed on its own wire, it catches fire.

An embodiment of the present disclosure allows most natural augmentation for an object in a video or an image, as augmentation of the object is based on the situation of the object in the video or the image.

An embodiment of the present disclosure facilitates augmentation of future action where a user can see the impact of performing a certain action over an object without actually performing the same action using the object. For example, when John does packaging of fruits in a retail shop, he puts strawberries in a tray and focuses his camera invoking the AR application that implements the embodiment described in this specification. The AR application brings in a matching cardboard box and augments over the tray image. John finds that it may be difficult to pack the tray due to a protruding strawberry. He replaces the protruding strawberry with a smaller one and uses a cardboard box of the same type for packaging. This approach saves John his time considerably as the problem is identified in advance.

An embodiment of the present disclosure supports adaptive learning from user inputs, thereby, enhancing the database library for subsequent AR rendering.

### Computing System

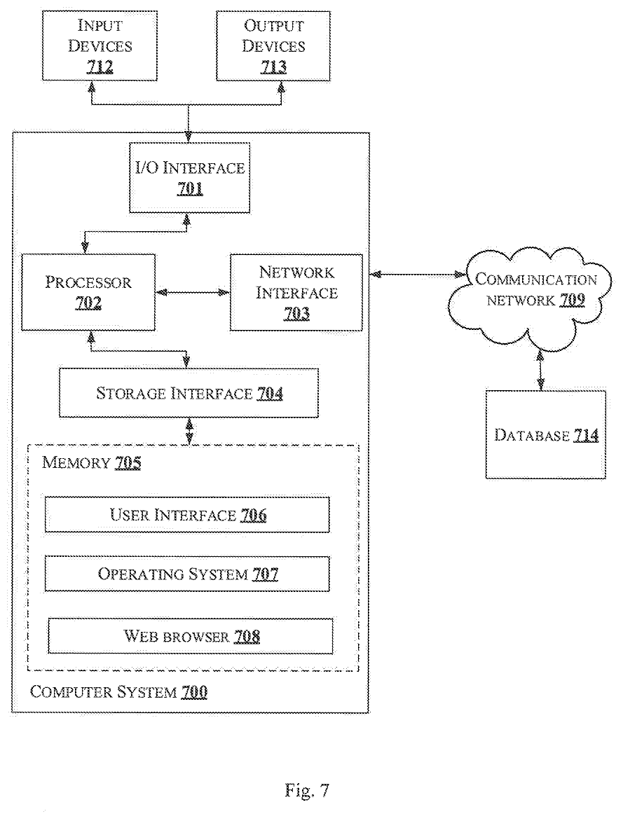

FIG. 7 illustrates a block diagram of an exemplary computer system 700 for implementing embodiments consistent with the present disclosure. In an embodiment, the computer system 700 may be used to implement the assistance system 107. The computer system 700 may include a central processing unit (“CPU” or “processor”) 702. The processor 702 may include at least one data processor for rendering Augmented Reality (AR) content that adapts to a changing content in a video or an image. The processor 702 may include specialized processing units such as, integrated system (bus) controllers, memory management control units, floating point units, graphics processing units, digital signal processing units, etc.

The processor 702 may be disposed in communication with one or more input/output (I/O) devices (not shown) via I/O interface 701. The I/O interface 701 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HISPA+), global system for mobile communications (GSM), long-term evolution (LTE), WiMax, or the like), etc.

Using the I/O interface 701, the computer system 700 may communicate with one or more I/O devices such as input devices 712 and output devices 713. For example, the input devices 712 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 713 may be a printer, fax machine, video display (e.g,, Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 700 consists of the assistance system 107. The processor 702 may be disposed in communication with the communication network 709 via a network interface 703. The network interface 703 may communicate with the communication network 709. The network interface 703 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 709 may include, without limitation, a direct interconnection, local area network (LAN), wide area network (WAN), wireless network (e.g., using Wireless Application Protocol), the Internet, etc. Using the network interface 703 and the communication network 709, the computer system 700 may communicate with a database 714. The network interface 703 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 709 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 702 may be disposed in communication with a memory 705 (e.g., RAM, ROM, etc. not shown in FIG. 7) via a storage interface 704. The storage interface 704 may connect to memory 705 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, user interface 706, an operating system 707 etc. In some embodiments, computer system 700 may store user/application data, such as, the data, variables, records, etc., as described in this disclosure. Such databases may be implemented as fault-tolerant, relational, scalable, secure databases such as Oracle or Sybase.

The operating system 707 may facilitate resource management and operation of the computer system 700, Examples of operating systems 707 include, without limitation, APPLE MACINTOSHR OS X, UNIXR, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLER IOS™, GOOGLER ANDROID™, BLACKBERRYR OS, or the like.

In some embodiments, the computer system 700 may implement a web browser 708 stored program component. The web browser 708 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 708 may utilize facilities such as AJAX™, DHTML™, ADOBE® FLASH™, JAVASCRIPT™, JAVA™, Application Programming Interfaces (APIs), etc. In some embodiments, the computer system 700 may implement a mail server (not shown in FIG.) stored program component. The mail server may be an Internet mail server such as Microsoft Exchange, or the like. The mail server may utilize facilities such as ASP™, ACTIVEX™, ANSI™ C++/C#, MICROSOFT®, NEI™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 700 may implement a mail client (not shown in FIG.) stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure renders AR content that adapts to a changing content in a video or an image, thereby enhancing user-experience.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself

The illustrated operations of FIGS. 3a, 3b and 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference number | Description |
|---|---|
| 100 | Environment |
| 101 | User device |
| 103 | Database |
| 105 | Communication network |
| 107 | Assistance system |
| 111 | I/O interface |
| 113 | Memory |
| 115 | Processor |
| 200 | Data |
| 201 | Object data |
| 203 | AR content data |
| 205 | Meta-block data |
| 207 | Other data |
| 211 | Modules |
| 213 | AR object extractor module |
| 215 | Object associator module |
| 217 | Object augmenter module |
| 219 | Action augmenter module |
| 221 | Renderer module |
| 223 | Assisted trainer module |
| 225 | Other modules |
| 700 | Computer system |
| 701 | I/O interface |
| 702 | Processor |
| 703 | Network interface |
| 704 | Storage interface |
| 705 | Memory |
| 706 | User interface |
| 707 | Operating system |
| 708 | Web browser |
| 709 | Communication network |
| 712 | Input devices |
| 713 | Output devices |
| 714 | Database |

What is claimed is:

1. A method of rendering Augmented Reality (AR) content, the method comprising:
receiving, by an AR assistance system, real-time input data from a user device;
identifying, by the AR assistance system, a plurality of objects in the real-time input data;
determining, by the AR assistance system, association between the plurality of objects in the real-time input data and metadata of the plurality of objects;
determining, by the AR assistance system, one or more similar associated objects from a plurality of historic objects in a database based on the determined association;
selecting, by the AR assistance system, one of the one or more similar associated objects based on a weightage, wherein the weightage is assigned based on a similarity of metadata between each of the identified plurality of objects in the real-time input data and each of the objects in the similar associated objects;
selecting, by the AR assistance system, at least one of an AR object and an AR action from the database for the selected similar associated objects; and
rendering, by the AR assistance system, the at least one of an AR object and an AR action, with the real-time input data.

2. The method as claimed in claim 1, wherein the database is populated by:
receiving, by the AR assistance system, historic input data from one or more data sources;
segmenting, by the AR assistance system, the plurality of historic objects in the historic input data;
identifying, by the AR assistance system, correlation between the plurality of historic objects and metadata of the plurality of historic objects;
associating, by the AR assistance system, the at least one of an AR object and an AR action with the identified correlation and the metadata of the plurality of historic objects; and
storing, by the AR assistance system, the at least one of an AR object and an AR action with the identified correlation and the metadata of the plurality of historic objects in the database.

3. The method as claimed in claim 2, wherein the real-time input data and the historic input data are at least one of image and video.

4. The method as claimed in claim 2, further comprises:
updating, by the AR assistance system, the database with new objects, correlation amongst the new objects and the plurality of historic objects and the metadata of the new objects at pre-defined intervals of time for adaptive learning.

5. The method as claimed in claim 1, wherein the metadata comprises at least one of location of objects, title of objects, type of objects, interaction among objects, action associated with objects, sound associated with objects and information related to events associated with objects.

6. The method as claimed in claim 1, wherein the rendering comprises:
superimposing, by the AR assistance system, the at least one of AR object and AR action over the real-time input data; and
providing, by the AR assistance system, the superimposed real-time input data to the user device.

7. The method as claimed in claim 1, wherein the rendering comprises:
receiving, by the AR assistance system, at least one modified object from the user device;
determining, by the AR assistance system, one or more similar objects from the plurality of historic objects in the database based on the at least one modified object;
selecting, by the AR assistance system, at least one of modified AR object and modified AR action from the database for the determined one or more similar objects;
superimposing, by the AR assistance system, at least one of modified AR object and modified AR action along with the at least one modified object over the real-time input data; and
providing, by the AR assistance system, the superimposed real-time input data to the user device.

8. An assistance system for rendering Augmented Reality (AR) content, the system comprising:
a processor; and
a memory communicatively coupled to the processor, wherein the memory stores processor-executable instructions, which on execution, cause the processor to:
receive real-time input data from a user device;
identify a plurality of objects in the real-time input data;
determine association between the plurality of objects in the real-time input data and metadata of the plurality of objects;
determine one or more similar associated objects from a plurality of historic objects in a database based on the determined association;
select one of the one or more similar associated objects based on a weightage, wherein the weightage is assigned based on a similarity of metadata between each of the identified plurality of objects in the real-time input data and each of the objects in the similar associated objects;
select at least one of an AR object and an AR action from the database for the selected similar associated objects; and
render the at least one of an AR object and an AR action, with the real-time input data.

9. The assistance system as claimed in claim 8, the processor is configured to populate the database by:
receiving historic input data from one or more data sources;
segmenting the plurality of historic objects in the historic input data;
identifying correlation between the plurality of historic objects and metadata of the plurality of historic objects;
associating the at least one of an AR object and an AR action with the identified correlation and the metadata of the plurality of historic objects; and
storing the at least one of an AR object and an AR action with the identified correlation and the metadata of the plurality of historic objects in the database.

10. The assistance system as claimed in claim 9, wherein the real-time input data and the historic input data are at least one of image and video.

11. The assistance system as claimed in claim 9, the processor is configured to:
update the database with new objects, correlation amongst the new objects and the plurality of historic objects and the metadata of the new objects at pre-defined intervals of time for adaptive learning.

12. The assistance system as claimed in claim 8, wherein the metadata comprises at least one of location of objects, title of objects, type of objects, interaction among objects, action associated with objects, sound associated with objects and information related to events associated with objects.

13. The assistance system as claimed in claim 8, wherein the processor is configured to:
superimpose the at least one of AR object and AR action over the real-time input data; and
provide the superimposed real-time input data to the user device.

14. The assistance system as claimed in claim 8, wherein the processor is configured to:
receive at least one modified object from the user device;
determine one or more similar objects from the plurality of historic objects in the database based on the at least one modified object;
select at least one of modified AR object and modified AR action from the database for the determined one or more similar objects;
superimpose at least one of modified AR object and modified AR action along with the at least one modified object over the real-time input data; and
provide the superimposed real-time input data to the user device.

15. A non-transitory computer readable medium including instructions stored thereon that when processed by at least one processor cause an assistance system to perform operations comprising:
receiving real-time input data from a user device;
identifying a plurality of objects in the real-time input data;
determining association between the plurality of objects in the real-time input data and metadata of the plurality of objects;
determining one or more similar associated objects from a plurality of historic objects in a database based on the determined association;
selecting one of the one or more similar associated objects based on a weightage, wherein the weightage is assigned based on a similarity of metadata between each of the identified plurality of objects in the real-time input data and each of the objects in the similar associated objects;
selecting at least one of an AR object and an AR action from the database for the selected similar associated objects; and
rendering the at least one of an AR object and an AR action, with the real-time input data.
